(19) United States
(12) Patent Application Publication
(10) Pub. No.: US 2013/0157017 A1
(43) Pub. Date: Jun. 20, 2013

(54) SECURE BEAM, IN PARTICULAR STRONG FRAME OF FUSELAGE, AND AIRCRAFT FUSELAGE PROVIDED WITH SUCH FRAMES

(71) Applicant: Airbus Operations (SAS), Toulouse (FR)

(72) Inventors: Julien Guillemaut, Getafe Madrid (ES); Guillaume Gallant, Lareole (FR); Jerome Colmagro, Toulouse (FR)

(73) Assignee: AIRBUS OPERATIONS (SAS), Toulouse (FR)

(21) Appl. No.: 13/714,789

(22) Filed: Dec. 14, 2012

(30) Foreign Application Priority Data
Dec. 15, 2011 (FR) 1161666

(51) Int. Cl. B64C 1/06

(52) U.S. Cl. CPC B64C 1/062
USPC 428/172; 428/223; 428/174

(57) ABSTRACT

An arrangement for freeing the structures of fail-safe type from the damage tolerance criterion and to allow a significantly improved fatigue resistance, while producing a weight saving. This is provided by forming a composite hybrid structure in a configuration that makes it possible to combine the advantages of metal and of composite material. In a secure hybrid structure, at least two longitudinal structural spars are joined back to back by fastening means. One of the spars is metal and equipped with stability partitions, whereas another spar is made of a composite material with carbon fibers oriented in the direction of the forces to be predicted such that this spar exhibits a rigidity equivalent to that of the metal spar.

### BACKGROUND OF THE INVENTION

The invention relates to parts that are subject to strong traction and bending forces called beams, such as secure fuselage frames, in particular the strong fuselage frames. It also relates to an aircraft fuselage equipped with such frames.

Generally, a structure is said to be secure, or more specifically “fail-safe” (with secure reinforcement), when it exhibits a plurality of possible pathways for taking up the mechanical loads. In particular, a secure structure may be made up of two longitudinal metal spars joined together to act as the strong frame of an aircraft fuselage. Because of the high level of the forces applied, and the difficulties associated with manufacture, these frames are generally metal.

The certification of such a strong frame demands, for both of its spars, a mechanical resistance rated at 150% of the maximum possible forces encountered by the frame (so-called “extreme” loads). When one of the two spars is assumed broken, the 100% mechanical resistance to the maximum forces applied (so-called “limit” loads) must be demonstrated.

Since fuselage frames are usually made of metal, a main criterion in dimensioning these frames is the damage tolerance for the following reasons. According to this criterion, it is stipulated that the greatest of the cracks, which has not been detected in the course of an inspection, cannot be propagated to the critical size—defined as capable of totally ruining the structure—during the time interval between that inspection and the next inspection.

In order to measure the damage tolerance of an airplane fuselage frame, it is standard practice to follow a crack propagation model that makes it possible to evaluate the size of the crack or cracks as a function of the number of flights made. A structure of fuselage fail-safe frame type is made up of two longitudinal spars joined together on a side wall. The initial conditions generally accepted to establish the model consist in generating cracks of different sizes on each of the side walls of the spars of the fail-safe frame.

These cracks are taken into account at critical crack initiation sites. In the case that we are especially interested in, the fastenings used to join the two spars initiate the crack. In practice, because of a locally high stress concentration coefficient, linked, for example, to a form effect which induces overstresses, these sites are more often than not the critical crack initiation sites. Now, the cracks are propagated at speeds that depend on the size of these cracks. Thus, the spar exhibiting the initial crack of largest size will be subject to a greater crack propagation speed. When a crack has reached the critical break size, the corresponding spar is broken and the other spar is then overloaded because of the redistribution in the other frame of the forces from the broken frame, and in the skin of the fuselage. The overloading undergone by the remaining frame is, in these conditions, approximately 80%. This is referred to as “overall redistribution of the forces”. The propagation of the crack in the non-broken frame is then very rapid, which explains why the dimensioning criterion is damage tolerance.

Generally, means are therefore sought for enhancing the metal structures of secure (fail-safe) type with regard to their fatigue resistance—corresponding to the initiation of damage—and to their damage tolerance behavior, in other words damage propagation.

Also known from the US patent document US 2010/0316857 is a multilayer composite material incorporating a metal reinforcing layer. Such a material is intended to be used in areas where force is introduced, for example by screw or rivet, or connection areas. It is therefore limited to the cracks which start in these particular areas, for which protection means are generally provided.

In order to limit the propagation of the cracks, the conventional solutions consist in increasing the dimensions and/or in multiplying the number of link beams. These solutions are costly and increase the weight of the frame.

### SUMMARY OF THE INVENTION

The invention aims to improve the damage tolerance behavior of the strongly loaded parts of fail-safe type and to allow in particular for a significantly improved fatigue resistance, while obtaining a weight saving.

For this, the invention proposes to form a composite hybrid structure in a configuration that makes it possible to combine the advantages of metal and of composite material.

More specifically, the subject of the present invention is a secure beam comprising at least one structural part or spar secured to a support in the longitudinal direction by fastening means. The beam comprises at least two spars joined together by fastening means: one of the spars is metal and equipped with stability partitions, whereas a second spar is made of composite material.

This hybrid solution makes it possible to benefit from the stability of the partitions of the metal spar for all of the structure, and from the absence of damage propagation, in particular of the propagation of cracks, in the composite material of the other structural spar. Furthermore, the presence of a spar made of composite material allows for a weight saving compared to the all-metal solution.

According to preferred embodiments:
the fibers of the composite spar are oriented mainly in the direction of the forces to be predicted such that this spar exhibits a rigidity equivalent to that of the metal spar;
the spars are of profiled structure chosen from a “U”, “I” (that is to say plate), “L” and “T” shape;
the first metal spar has a “U” profile and a second spar is made of a carbon fiber composite material;
the spars are of identical form, with “U” profile and joined together by their webs;
the material of the metal spars is based on an aluminum or titanium alloy.

The invention also relates to a strong frame of an aircraft fuselage. This frame comprises the structure defined above with structural spars configured according to a geometry which can be adapted to an aircraft fuselage profile.

Another subject of the invention is an aircraft fuselage comprising a skin to which at least one frame wall as defined above is secured.

### BRIEF DESCRIPTION OF THE DRAWINGS

Other aspects and advantages of the present invention will become apparent on reading the following detailed description, with reference to the appended figures which represent, respectively:

FIGS. 1 and 2, partial interior and rear face views of an aircraft fuselage on which a strong frame is mounted;

FIGS. 3a and 3b, schematic cross-sectional views of examples of a fail-safe hybrid frame according to the invention with, respectively, a composite spar of “U” profile and of plate profile;

FIG. 4, a side view of the geometry of a hybrid strong frame according to the invention, and

FIGS. 5 and 6, a rear fuselage view with cabin pressurization deformation and a schematic cross-sectional view of a hybrid strong frame undergoing the bending forces following pressurization.

### DETAILED DESCRIPTION OF THE PREFERRED EMBODIMENTS

Throughout the text, the qualifiers “internal” or “external” and their derivatives relate, respectively, to elements closer to or further away from the fuselage skin and, respectively, to elements facing toward or away from this fuselage skin. Moreover, the same reference signs designate identical elements in the appended figures.

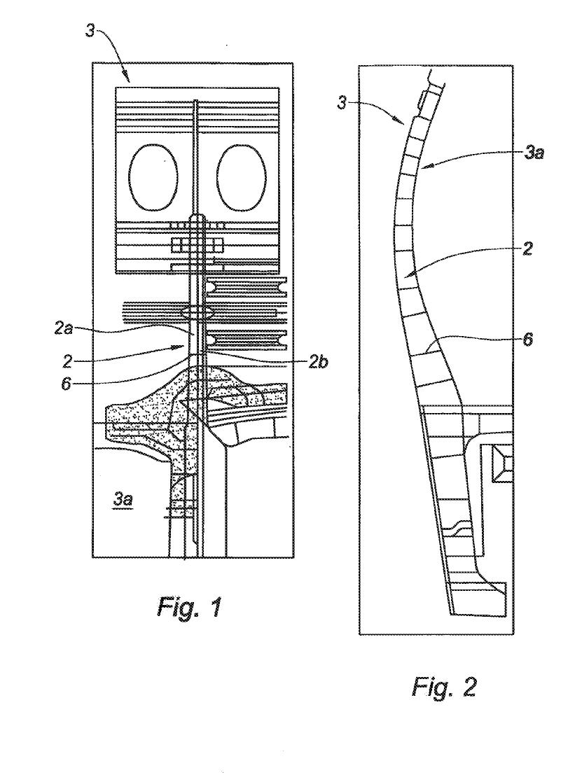

Referring to the front and rear views of FIGS. 1 and 2, a secure aircraft fuselage frame 2 is made up of one or more spars which can respond to the pressurization, and can therefore work under bending stress (with and overall “U” profile in the example). The spars 2 are fastened to an airplane fuselage skin 3. They may be bonded or co-bonded, that is to say baked with the fuselage, and secured by riveting, welding or equivalent to the internal face 3a of the skin 3. The spars are held together by fastenings distributed over their entire length. Partitions 6 are also distributed over their entire length in order to ensure the mechanical stability of the spars. The assembly of the duly joined spars forms a secure frame 2 of fail-safe type.

According to the invention, such a beam 2 is a beam that is overall similar in form to that previously used and made up of two distinct parts, 2a and 2b, each part consisting of a single and unique material, different for each of these two parts: the part 2a is made of metal material and the part 2b is made of composite material. This is thus referred to as hybrid beam assembly.

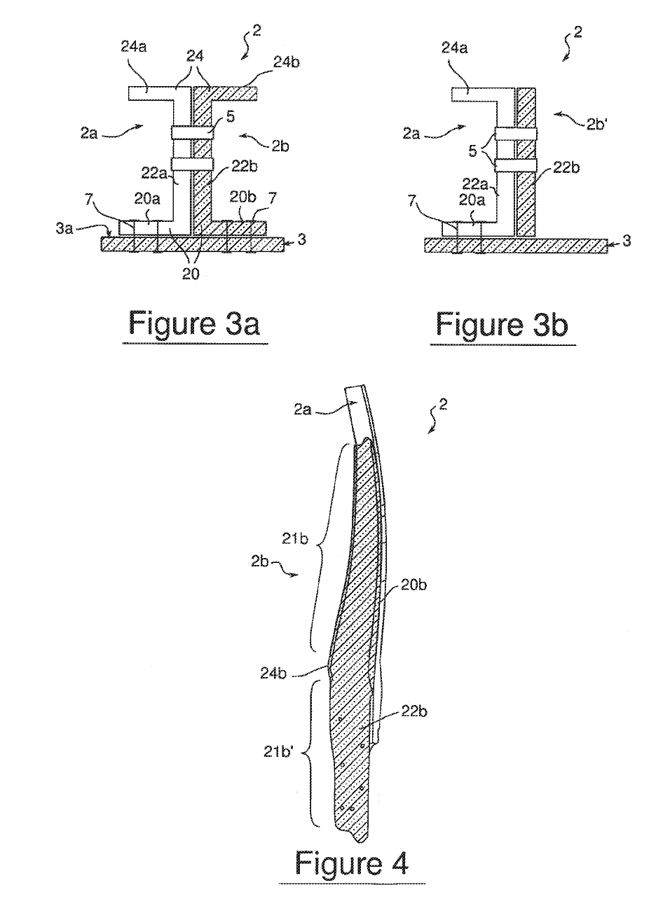

A first exemplary hybrid strong frame 2 is more particularly illustrated by the cross-sectional view of FIG. 3a. The first spar 2a is made of titanium and the second spar 2b of composite material. This material is manufactured based on a polymer (usually of epoxy resin) reinforced by carbon fibers, known, for example, as CFRP (carbon fiber reinforced polymer). The carbon fibers are previously oriented in the direction of the forces to increase the rigidity of the spar to match that of the metal spar.

Each of the spars 2a and 2b of the strong frame 2 exhibits, in cross section, the same geometry:
a bottom half-flange or foot 20a, 20b, bonded and fastened by bolts 7 to the internal face 3a of the fuselage skin 3;
a web 22a, 22b which extends substantially at right angles to the respective half-flanges 20a, 20b and to the skin 3, and
a half-wing 24a, 24b which extends parallel to the internal half-flanges 20a, 20b by a width slightly smaller than that of these internal half-flanges.

The spars 2a and 2b are joined together by metal fastenings 5 along their webs 22a, 22b. These spars are therefore joined together “back to back” by their webs and each have a “U” profile form, the sides of which are formed by the internal half-flanges 20a, 20b and the half-wings 24a, 24b framing the base of the “U” formed by the webs 22a, 22b.

The internal half-flanges 20a and 20b form the flange 20 of the frame 2 and the two half-wings 24a and 24b form a wing 24.

According to a variant illustrated in FIG. 3b, the frame 2 takes the same configuration apart from the second spar made of composite material. In practice, the composite spar 2b′ is then in the form of a plate, that is to say it comprises only the web 22b, with neither wing nor flange. This variant allows for a saving in cost and adaptation to the environment without compromising the damage tolerance.

The hybrid strong frame 2 makes it possible to stop the propagation of the cracks. In practice, a defect initiated in the metal spar 2a will be propagated until this spar breaks, which will generate a mechanism of redistribution of the forces in the second spar 2b or 2b′. However, the damage propagation is stopped because the cracks are not propagated in the composite part.

By retaining metal as the material of the spar 2a, the stability of the frame 2 as a whole is assured with the presence of partitions 6 which are conventionally used to equip the metal frames.

The spars 2a and 2b (or 2b′) both make it possible to take up the bending forces applied to the strong frame 2 when said spars are intact. However, each of the spars advantageously offers different functions: the stability of the hybrid strong frame 2 as a whole is ensured by the metal spar 2a and the composite spar 2b or 2b′ makes it possible to stop the propagation of cracks in the hybrid strong frame 2. This composite spar therefore provides an additional function of residual resistance in the case of breakage of the metal frame subject to the initiation and propagation of cracks.

The geometry of a hybrid strong frame 2 according to the invention is more specifically illustrated by the side view of FIG. 4. The composite spar 2b has two successive parts of different configurations: a part 21b of “U” profile, with half-flange 20b and half-wing 24b as represented in cross section by FIG. 3a, and a part 21b′ in the form of a plate or web 22b, with neither wing nor flange, as illustrated by FIG. 3b. The spar made of titanium 2a retains a “U” profile over its entire length.

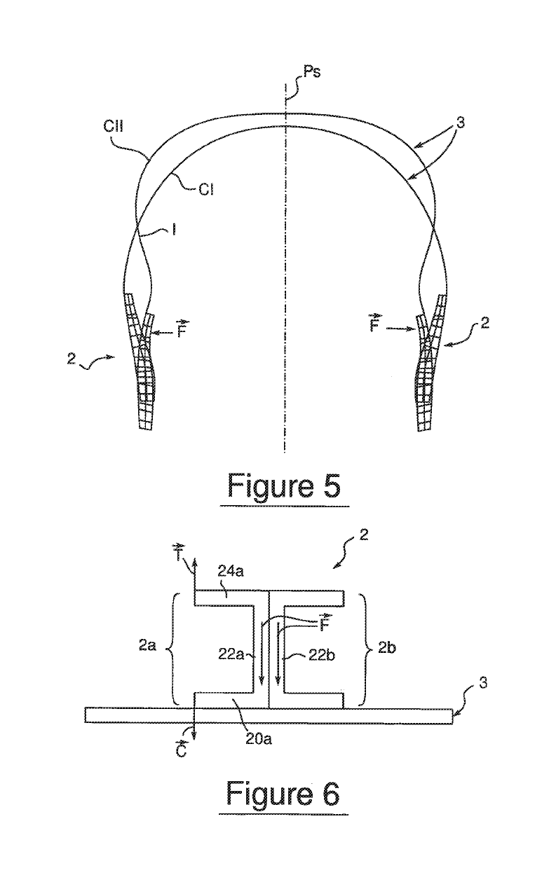

Referring to FIGS. 5 and 6, the hybrid frame is illustrated in its bending behavior. In a schematic rear view (FIG. 5), the cabin pressurization alters the deformation of the fuselage 3 from a continuous curvature CI to a profile with inverted double curvature CII (with a point of inflexion “I”), symmetrically relative to a plane of central symmetry Ps. The frames 2 then undergo, because of the change of curvature—changing from CI to CII—and over a significant length, a deflection \vec{F} linked to the cabin pressurization.

In the schematic cross-sectional view (FIG. 6), it can be seen more specifically that the metal half-wing 24a of the spar 2a of the frame 2 is subject to traction stress \vec{T}, the metal half-flange 20a is subject to compression stress \vec{C}, and the webs 22a and 22b of the frame 2 are subject to bending stress \vec{F}. The metal half-wing 24a, and therefore the entire frame 2, improves its fatigue resistance compared to an all-metal frame because of the flexion of the composite spar 2b, and all the more so when the traction force is greater than the compression force.

The invention is not limited to the exemplary embodiments described and represented. It is, for example, possible for a part of the metal spar to be replaced by a part made of composite material without the hybrid nature of the frame being compromised. Furthermore, the beams according to the invention can be associated with other spars, to form consolidated parts, for example a structure with two “U” shaped metal spars joined on either side of a composite wall. Moreover, the composite material may be based on carbon fibers, glass fibers or equivalent.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A secure beam comprising at least one structural part or spar intended to be secured to a support by fastening means in the longitudinal direction, said beam comprising a first spar which is metal and which is equipped with stability partitions,
wherein this beam comprises at least two spars joined together by fastening means, and wherein a second spar is made of composite material.

2. The hybrid beam as claimed in claim 1, in which the fibers of the composite spar are oriented mainly in the direction of the forces to be predicted such that this spar exhibits a rigidity equivalent to that of the metal spar.

3. The hybrid beam as claimed in claim 1, in which the spars are of profiled structure chosen from a “U”, “I”, “L” and “T” shape.

4. The hybrid beam as claimed in claim 1, in which the first metal spar has a “U” profile and the second spar is made of a carbon fiber composite material.

5. The hybrid beam as claimed claim 1, in which the spars are of identical form, with “U” profile and joined together by their webs.

6. The hybrid beam as claimed in claim 1, in which the material of the metal spars is based on an aluminum or titanium alloy.

7. A strong frame of an aircraft fuselage, wherein this frame comprises the hybrid structure as claimed in claim 1, with structural spars configured according to a geometry which can be adapted to an aircraft fuselage profile.

8. An aircraft fuselage comprising a skin to which at least one flange of a frame as claimed in the claim 1 is secured.
